(19) United States
(12) Patent Application Publication
(10) Pub. No.: US 2026/0088532 A1
(43) Pub. Date: Mar. 26, 2026

(54) Electrical Connector

(71) Applicant: Tyco Electronics (Shanghai) Co., Ltd., Shanghai (CN)

(72) Inventors: Hengkang Wu, Dongguan (CN); David (Xinjie) Zhang, Shanghai (CN)

(73) Assignee: Tyco Electronics (Shanghai) Co., Ltd., Shanghai (CN)

(21) Appl. No.: 19/336,834

(22) Filed: Sep. 23, 2025

(30) Foreign Application Priority Data
Sep. 24, 2024 (CN) 202411338878.6

(51) Int. Cl. H01R 12/70

(52) U.S. Cl. CPC H01R 12/707

(57) ABSTRACT

An electrical connector includes a shell, an insulating housing, a pair of terminal assemblies, a fixing member installed within the insulating housing and having an opening on a side, a retaining member at least partially retained by the fixing member, and a grounding member between the fixing member and the retaining member. The insulating housing, open at both ends, is installed within the shell. Each terminal assembly is disposed within the insulating housing and has a plurality of conductive terminals. The plurality of conductive terminals include at least one pair of signal terminals and at least one pair of ground terminals. Each conductive terminal has a free end and an installation segment at an end opposite the free end. The grounding member is in conductive connection with respective installation segments of respective ground terminals of one terminal assembly and has a latching hook portion insertion fit with the opening.

### CROSS-REFERENCE TO RELATED APPLICATIONS

This application claims the benefit of the filing date under 35 U.S.C. § 119(a)-(d) of Chinese Patent Application No. 202411338878.6, filed on Sep. 24, 2024.

### FIELD OF THE INVENTION

The present disclosure relates to an electrical connector and, more particularly, to an electrical connector capable of exhibiting improved structural strength against temperature-induced deformation during processing.

### BACKGROUND OF THE INVENTION

Electrical connectors are electronic components for transmitting and exchanging current, signals, etc., between electronic system devices. Acting as nodes, independently or with cables, electrical connectors transmit current or signals between devices, components, equipment, and systems, ensuring that signal distortion and energy loss variations do not occur between systems. They are essential fundamental elements constituting the connection of an entire system. For example, Input/Output (I/O) modules are typically used for connections between switches, and between switches and servers.

In the prior art for data communication fields, connector assemblies are commonly used to achieve signal transmission between two printed circuit boards (PCBs). Specifically, as a typical example, such a connector assembly mainly includes two connectors that mate with each other. These two connectors are respectively mounted on the two printed circuit boards and then mated together to achieve signal transmission between the two printed circuit boards. Conventional electrical connectors typically include an insulating housing (such as a plastic housing) and contact conductive terminals (including signal terminals and ground terminals) assembled within the insulating housing. Through the respective contact conductive terminals of the two electrical connectors assembled within the same electrical connector assembly, physical interconnection and electrical connection between the two circuit boards are achieved.

In the prior art, in conventional electrical connectors, the conductive terminals include signal terminals and ground terminals. The ground terminals are typically grounded, for example, via a conductive connection to a grounding member. Specifically, this is achieved, for instance, by conductively connecting the ground terminals to solder feet of the grounding member through means such as soldering. Furthermore, to enhance the structural strength of the typically elongated grounding member and ensure coplanarity of the solder feet, it is typical to additionally provide a retaining member made of an insulating material, such as plastic, on the backside of the grounding member. This retaining member extends in a length direction of the grounding member and is fixed, for example, at both ends to the insulating housing.

However, considering that during manufacturing processes, such as soldering, components of the electrical connector are subjected to elevated temperatures causing deformation, particularly the retaining member fixed at both ends may experience arching deformation in its unconstrained middle portion in its length direction due to temperature rise. This adversely affects structural strength and solder foot coplanarity.

Therefore, in the prior art, there is an urgent need for an improved electrical connector that, for example, by providing mutually engaging additional structures on the grounding member and other fixed structures, can achieve effective constraint on the middle portion of the retaining member, thereby suppressing structural deformation of the retaining member caused by elevated temperatures, enhancing the structural strength of the connector's components, and improving solder foot coplanarity.

### SUMMARY OF THE INVENTION

An electrical connector includes a shell, an insulating housing, a pair of terminal assemblies, a fixing member installed within the insulating housing and having an opening on a side, a retaining member at least partially retained by the fixing member, and a grounding member between the fixing member and the retaining member. The insulating housing, open at both ends, is installed within the shell. Each terminal assembly is disposed within the insulating housing and has a plurality of conductive terminals. The plurality of conductive terminals include at least one pair of signal terminals and at least one pair of ground terminals. Each conductive terminal has a free end and an installation segment at an end opposite the free end. The grounding member is in conductive connection with respective installation segments of respective ground terminals of one terminal assembly and has a latching hook portion insertion fit with the opening.

### BRIEF DESCRIPTION OF DRAWINGS

The invention will now be described by way of example with reference to the accompanying figures, of which:

FIG. 1a is a perspective view of an electrical connector according to an embodiment;

FIG. 1b is another perspective view of the electrical connector of FIG. 1a;

FIG. 1c is a partially exploded view of the electrical connector of FIG. 1a;

FIG. 2a is a perspective view of internal components of the electrical connector of FIG. 1a in an assembled state;

FIG. 2b is a front view of the internal components of FIG. 2a in the assembled state of FIG. 2a;

FIG. 2c is a rear view of the internal components of FIG. 2a in the assembled state of FIG. 2a;

FIG. 2d is a top view of the internal components of FIG. 2a in the assembled state of FIG. 2a;

FIG. 2e is a bottom view of the internal components of FIG. 2a in the assembled state of FIG. 2a;

FIG. 2f is a left-side view of the internal components of FIG. 2a in the assembled state of FIG. 2a;

FIG. 2g is a right-side view of the internal components of FIG. 2a in the assembled state of FIG. 2a;

FIG. 3a is a schematic perspective view of a grounding member and a fixing member of the internal components of FIG. 2a in a separated state;

FIG. 3b is another schematic perspective view of the grounding member of FIG. 3a and the fixing member of FIG. 3a in the separated state of FIG. 3a;

FIG. 3c is a front view of the grounding member of FIG. 3a and the fixing member of FIG. 3a in the separated state of FIG. 3a;

FIG. 3d is a rear view of the grounding member of FIG. 3a and the fixing member of FIG. 3a in the separated state of FIG. 3a;

FIG. 3e is a top view of the grounding member of FIG. 3a and the fixing member of FIG. 3a in the separated state of FIG. 3a;

FIG. 3f is a bottom view of the grounding member of FIG. 3a and the fixing member of FIG. 3a in the separated state of FIG. 3a;

FIG. 3g is a left-side view of the grounding member of FIG. 3a and the fixing member of FIG. 3a in the separated state of FIG. 3a;

FIG. 3h is a right-side view of the grounding member of FIG. 3a and the fixing member of FIG. 3a in the separated state of FIG. 3a;

FIG. 4 is a perspective view of a retaining member of the internal components of FIG. 2a:

FIG. 5 is a perspective view of the electrical connector of FIG. 1a with the fixing member of FIG. 3a and the retaining member of FIG. 4 not shown so that an overall arrangement of conductive terminals of the internal components of FIG. 2a can be seen; and

FIG. 6 is a perspective view of two terminal assemblies of the internal components of FIG. 2a.

### DETAILED DESCRIPTION

The present disclosure will now be described in detail with reference to the accompanying drawings, which are provided as illustrative examples of the present disclosure to enable those skilled in the art to practice the disclosure. It should be noted that the following drawings and examples are not intended to limit the scope of the present disclosure to a single embodiment; rather, other embodiments are possible by interchanging some or all of the elements described or illustrated. Furthermore, where known components may be used partially or entirely to implement certain elements of the present disclosure, only those parts of such known components necessary for understanding the present disclosure will be described, and detailed descriptions of other parts of such known components will be omitted to avoid obscuring the present disclosure. Unless otherwise specified herein, as will be understood by those skilled in the art, embodiments described as implemented in software should not be limited as such, but may include embodiments implemented in hardware or a combination of software and hardware, and vice versa. In this specification, embodiments showing a singular component should not be considered limiting; rather, unless explicitly stated otherwise herein, the present disclosure is intended to cover other embodiments including multiple identical components, and vice versa. Furthermore, the applicant does not intend any term in the specification or claims to be ascribed an uncommon or special meaning unless explicitly stated. Additionally, the present disclosure encompasses present and future known equivalents of the known components referred to herein by illustration.

Unless otherwise specified, the terms “bottom” and “top”, “upper” and “lower”, etc., appearing in the content recorded in the present disclosure are relative concepts. And “respective” appearing in the content recorded in the present disclosure refers to the correspondence between components used in pairs and working cooperatively.

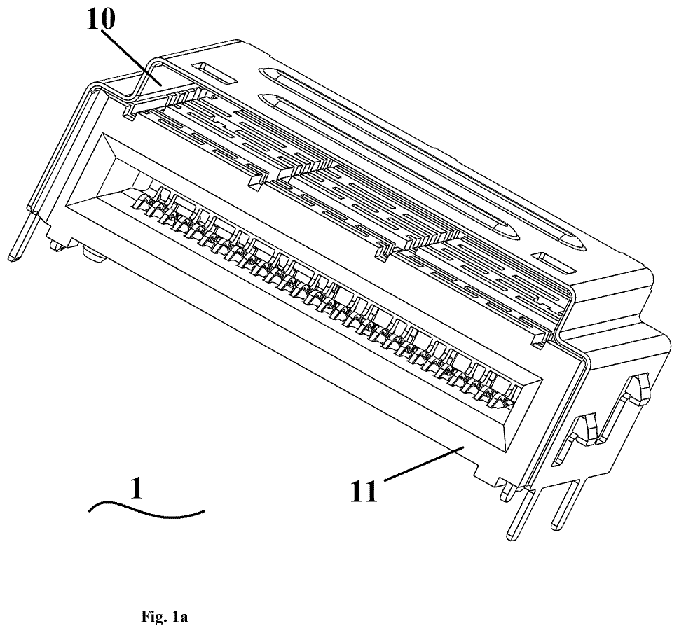

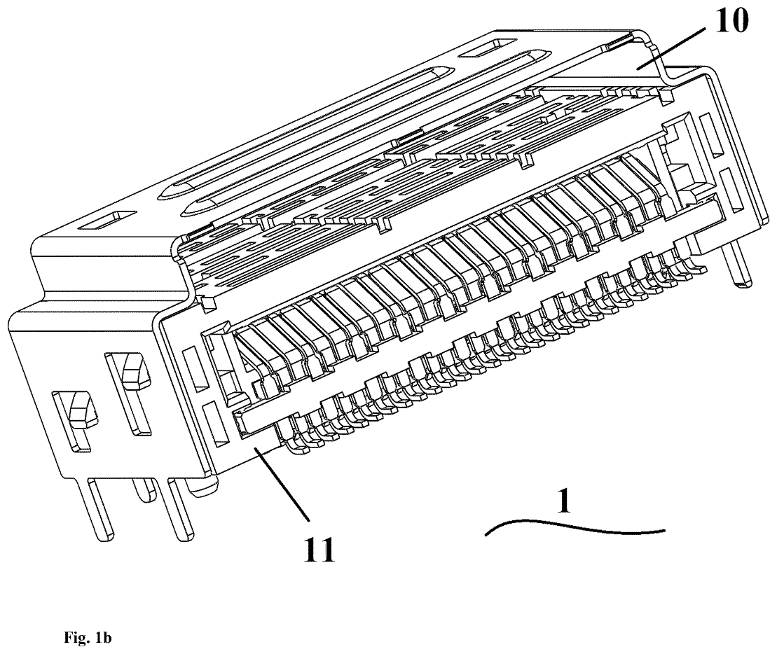

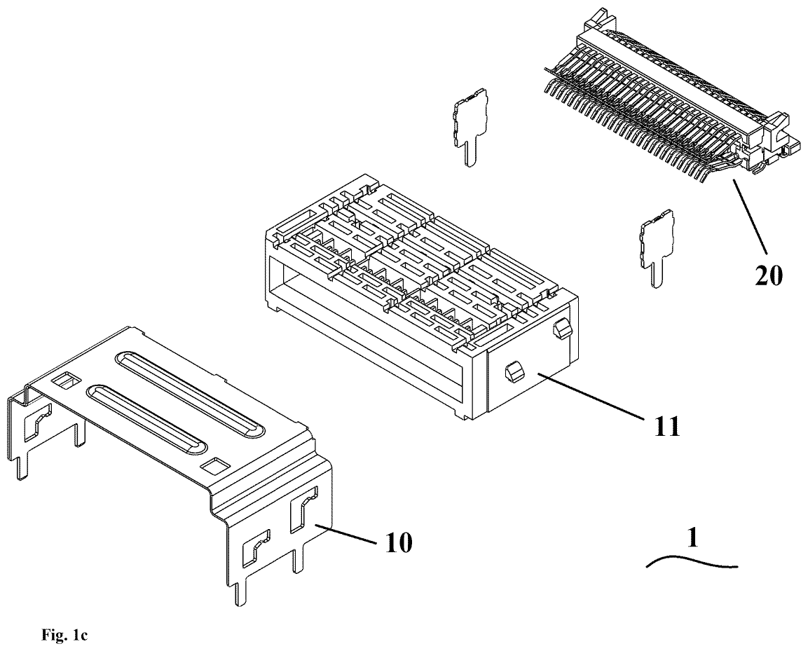

An exemplary embodiment of an electrical connector 1 will now be described with reference to FIG. 1a-6. As shown in FIG. 1c, the electrical connector 1 comprises a shell 10, an insulating housing 11, installed within the shell 10 and open at both ends in a longitudinal direction (the longitudinal direction being, for example, the length direction of the insulating housing 11, extending from one open end to the opposite open end), and internal components 20 disposed within the insulating housing 11.

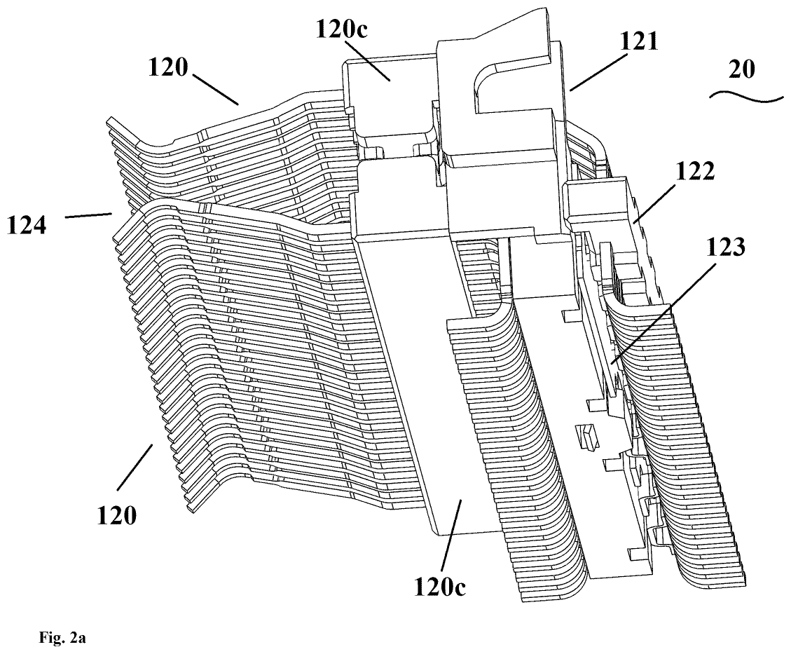

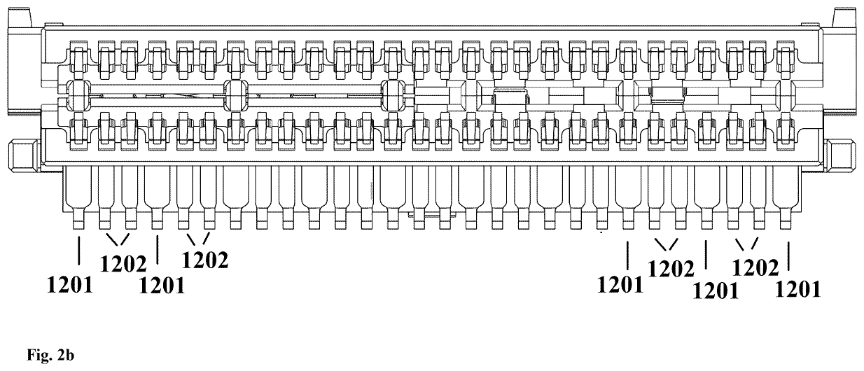

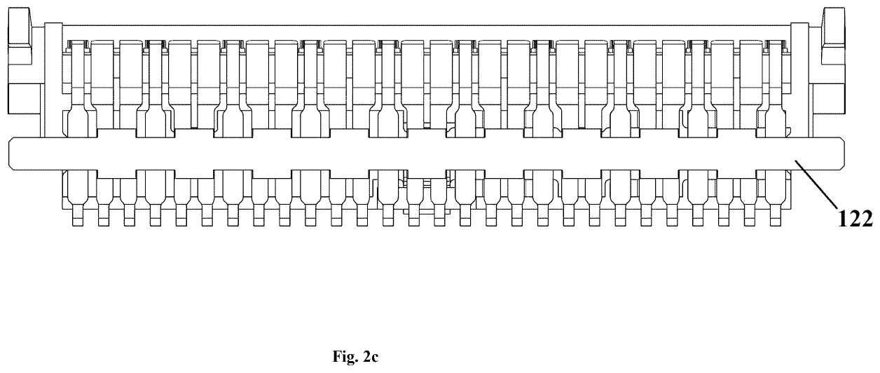

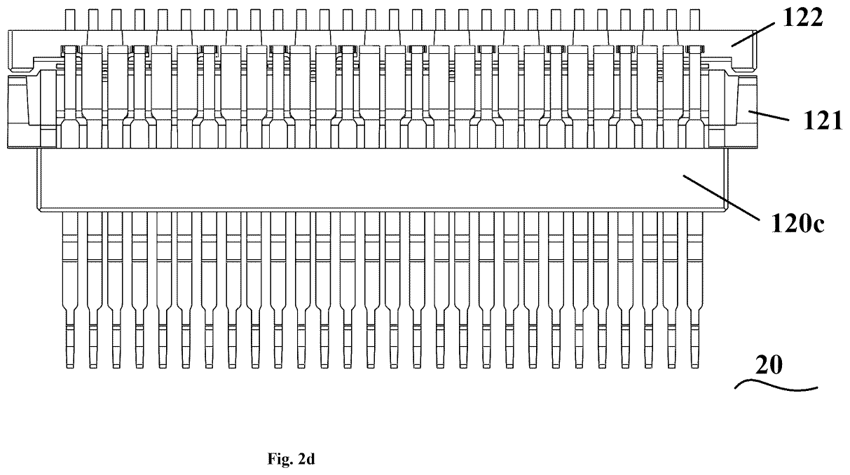

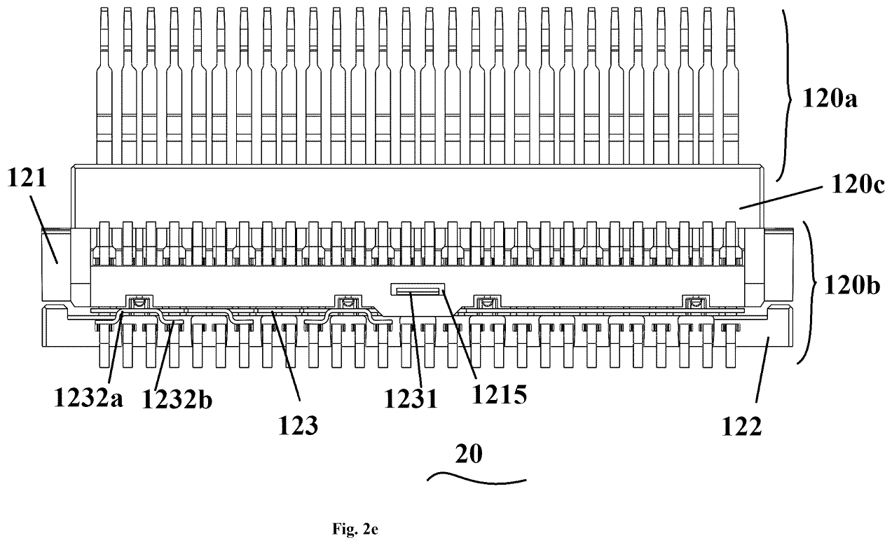

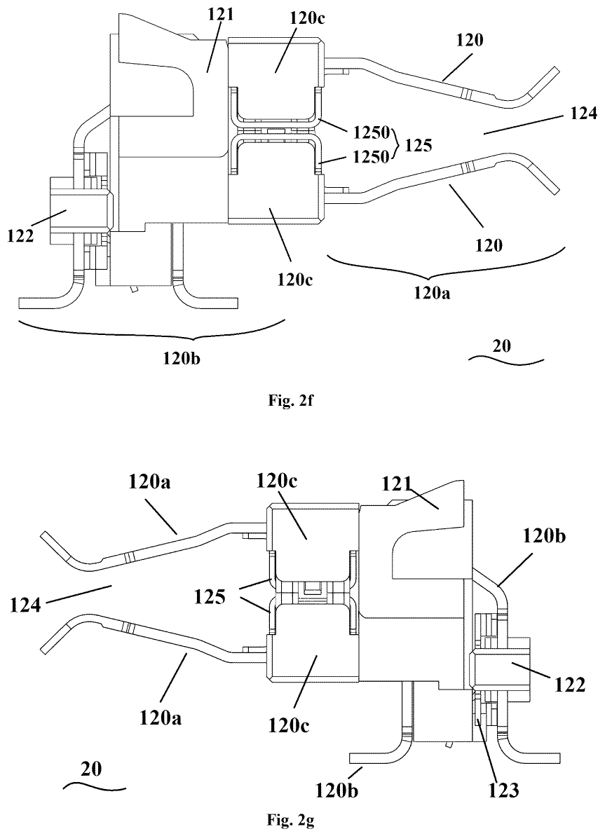

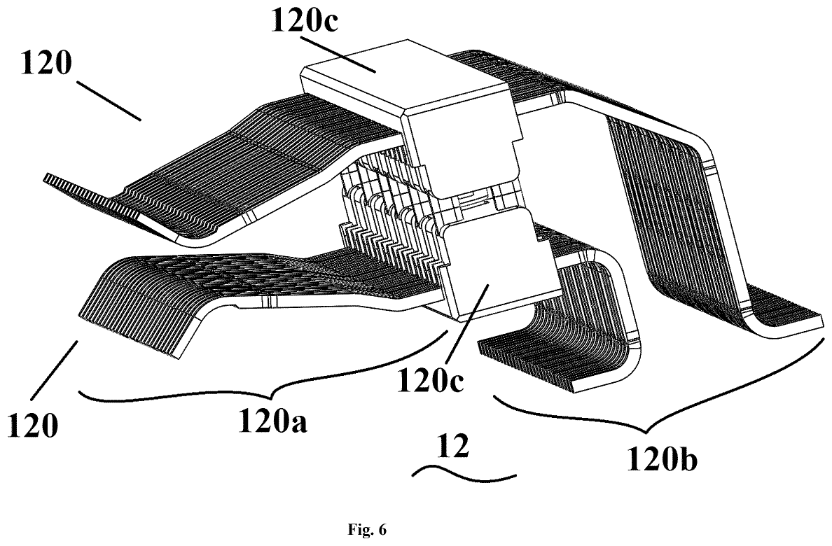

The internal components 20 include, for example: two terminal assemblies 12, as shown in FIG. 6, disposed within the insulating housing 11. Each terminal assembly 12 includes a plurality of conductive terminals 120, as shown in FIGS. 2a, 2f, 3a, and 6, extending parallel to the longitudinal direction and arranged side by side in a transverse direction perpendicular to the longitudinal direction (the transverse direction being, for example, the width direction of the insulating housing 11 orthogonal to the length direction). As shown in FIG. 2b, the plurality of conductive terminals 120 includes at least one pair of signal terminals 1202 and at least one pair of ground terminals 1201 (both the signal terminals 1202 and the ground terminals 1201 are arranged in pairs and correspond one-to-one). As shown in FIGS. 2e-2f, 3a-3b, and 5-6, each conductive terminal 120 includes a free end (e.g., formed as an elastic bent arm for contacting a conductive terminal of a mating electrical connector) and an installation segment 120b at an opposite end.

As an example, for instance, the electrical connector 1 includes the shell 10 made of metal and the insulating housing 11 made of an insulating material. More specifically, in some applications, for example, the insulating housing 11 is made of a plastic part such as LCP material. And more specifically, in some applications, the shell 10 may be, for example, a shell 10 made of a metal material such as 304 stainless steel. The insulating housing 11 is installed within the shell 10, for example, by providing mutually engageable protrusions and recesses on their side walls. In some embodiments, as shown in the figures, the shell 10 may be formed with, for example, first mounting legs for mounting on a circuit board, and/or the insulating housing 11 may also be formed with second mounting legs for mounting on the circuit board.

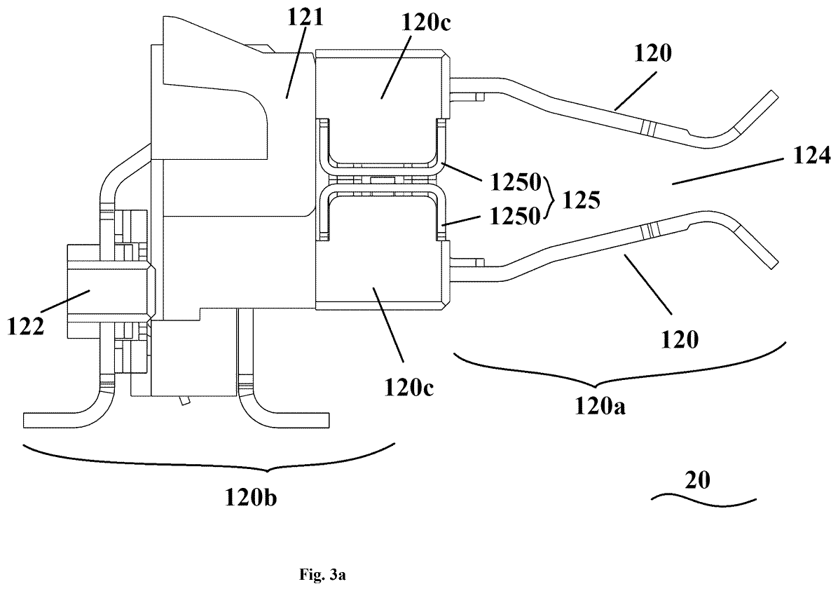

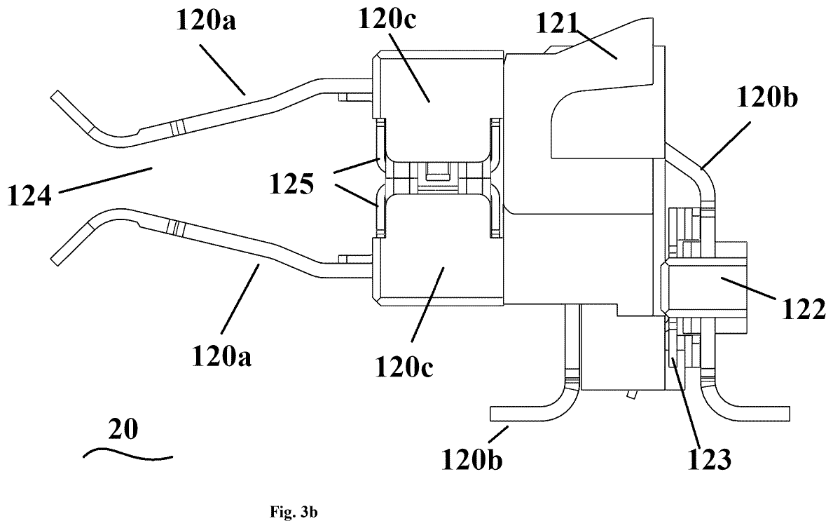

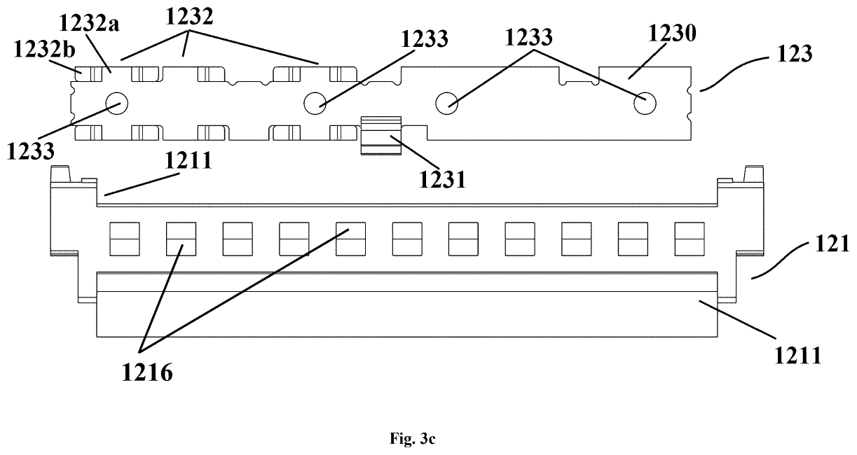

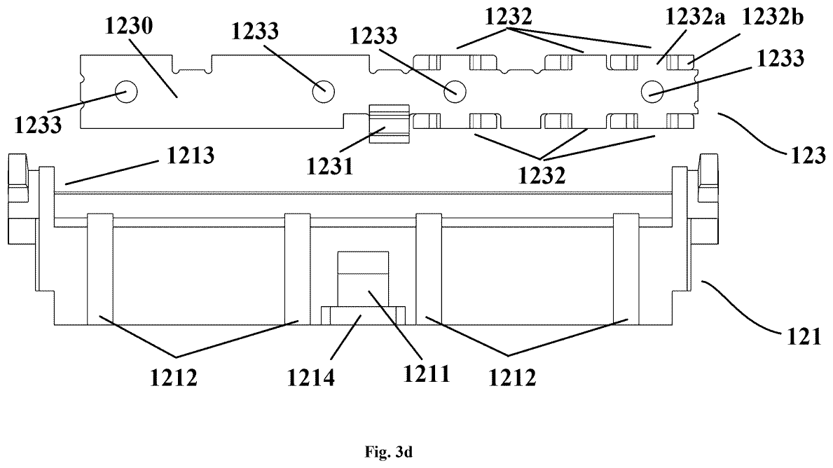

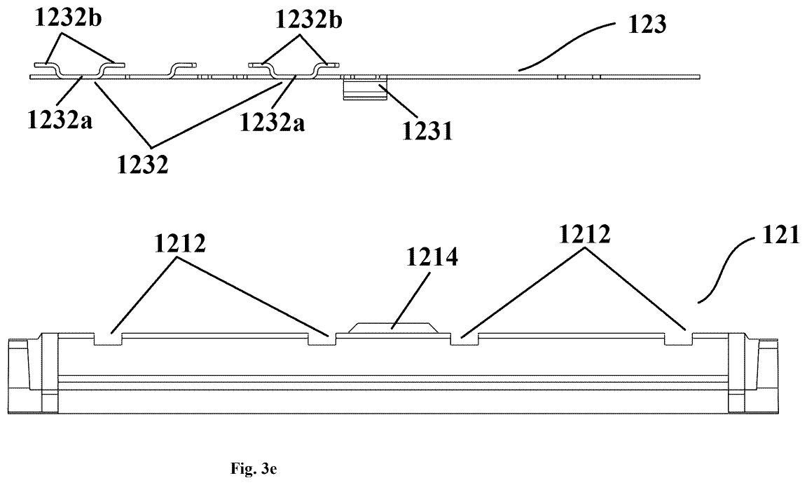

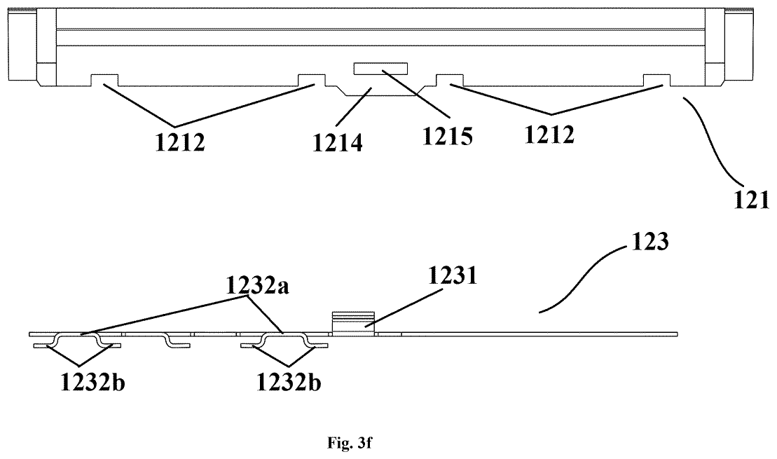

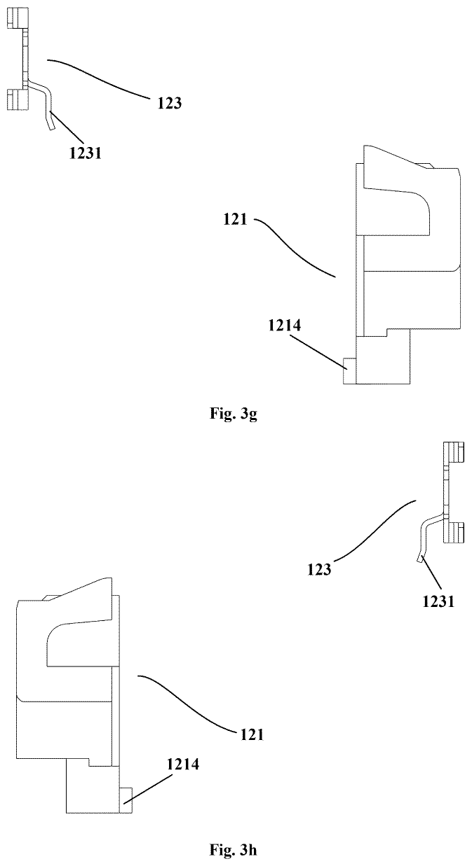

The internal components 20 in the electrical connector 1 may further include: a fixing member 121, as shown in FIGS. 2a and 2d-3h, installed within the insulating housing 11 and having an opening 1211, as shown in FIGS. 3c-3d, on one side, for example, an opening 1211 extending through the fixing member 121 itself in a vertical direction perpendicular to both the longitudinal direction and the transverse direction; a retaining member 122, as shown in FIGS. 2a, 2c-3b, and 4, at least partially retained by the fixing member 121 to eliminate translational degrees of freedom of the retaining member 122 in at least one direction (e.g., the transverse and/or longitudinal direction) and/or rotational degrees of freedom around at least one direction (e.g., the transverse and/or longitudinal direction); and a grounding member 123, as shown in FIGS. 2a, 2e, 2g, 3b-3h, and 5, located between the fixing member 121 and the retaining member 122 in the longitudinal direction, in conductive connection with the installation segments 120b of the respective ground terminals 1201 of one terminal assembly 12, and having a latching hook portion 1231, as shown in FIG. 3c-3f, adapted for insertion-fit engagement with the opening 1211. Thus, the retaining member 122 is essentially disposed on the backside of the grounding member 123 and serves to provide support stiffness for it. As an example, the grounding member 123 is made of a conductive metal material, and the fixing member 121 and the retaining member 122 are made of an insulating material, such as plastic.

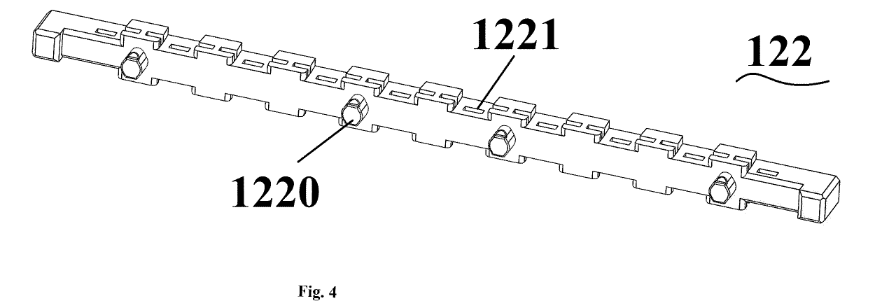

As shown in FIG. 3d, as a specific example, the side of the fixing member 121 facing the grounding member 123 has the opening 1211 and a plurality of slots 1212, each extending through the fixing member 121 in the vertical direction perpendicular to both the longitudinal and transverse directions. The side of the retaining member 122 facing the grounding member 123 has a plurality of protrusions 1220, as shown in FIG. 4, adapted to be insertably retained in the plurality of slots 1212. The retaining member 122 is fixed at both ends to the insulating housing 11. The grounding member 123 is provided with a plurality of holes 1233, as shown in FIGS. 3c-3d, adapted for passage of the plurality of protrusions 1220. Thus, the grounding member 123 disposed between the fixing member 121 and the retaining member 122, due to the protrusions 1220 passing through its holes and extending into the respective slots 1212, causes the retaining member 122 to follow the relative movement between the fixing member 121 and the grounding member 123, shifting or tending to shift accordingly.

Through this arrangement, for example, by utilizing mutually engaging additional structures provided on the grounding member 123 and other fixed structures (i.e., the latching hook portion 1231 on the grounding member 123 and the opening 1211 on the fixing member 121 are mutually adapted, e.g., in an insertion-latch type engagement), it is achieved in the electrical connector 1 that the retaining member 122, located on the backside of the grounding member 123, is not only constrained at both ends to the insulating housing 11, but also, following the relative locking engagement between the fixing member 121 and the grounding member 123 via the latching hook portion 1231 and the opening 1211, the retaining member 122 is also effectively constrained at its originally unconstrained middle portion in the transverse direction (i.e., the extending direction of the retaining member 122) by the mutually engaging additional structures. This can suppress the tendency of structural outward deformation of the retaining member 122 when the electrical connector 1 operates in an environment with elevated temperatures. Thus, with a simple structure, the structural strength of the components of the electrical connector 1 is enhanced, and simultaneously, the coplanarity among the plurality of solder feet 1232 of the grounding member 123 conductively connected to the respective ground terminals 1201 (more specifically, for example, at the installation segments 120b of at least some ground terminals 1201) can be improved.

As shown in FIGS. 3d-3f, the plurality of slots 1212 are recessed from the side surface of the fixing member 121 facing the grounding member 123 and linearly extend oppositely in the vertical direction through to two opposite edges of the fixing member 121, for respectively receiving and retaining the plurality of protrusions 1220 located on the side of the retaining member 122 facing the grounding member 123. The opening 1211 is recessed from the side surface of the fixing member 121 facing the grounding member 123 and extends unidirectionally in the vertical direction through to one edge of the fixing member 121. As shown in FIGS. 3d-3f, at the edge where the opening 1211 extends to, a stopper 1214 is provided, continuously extending across the opening 1211 in the transverse direction and arching towards the grounding member 123. For example, both ends of the stopper 1214 are integrated into the lateral edges of the opening 1211 in the transverse direction, and the portion of the stopper 1214 between its ends forms a continuous arched strip. Thus, the stopper 1214 and the inner wall of the opening 1211 together define a through hole 1215, as shown in FIG. 3f, extending in the vertical direction, essentially defining an opening 1211 of a chute-like type that is closed at the front face and open in the rear half, for respectively receiving and adapting to the insertion of the latching hook portion 1231 therein.

Therefore, through the specific arrangement of the retaining member 122 as described above, not only are its ends fixed to the insulating housing 11, but its multiple protrusions 1220 extend through the holes in the grounding member 123 and are then inserted and constrained within the respective plurality of slots 1212 of the fixing member 121. This eliminates multiple degrees of freedom of movement of the retaining member 122 itself (although not completely fixed at these protrusions 1220, there is still clearance between the protrusions 1220 and the respective slots 1212 to allow for relative movement within a limited threshold range, permitting a certain degree of relative deflection or deformation between them when the grounding member 123 is inserted, for example, with the latching hook portion 1231 into the opening 1211 of the fixing member 121 and the protrusions 1220 into the respective slots 1212, thereby accommodating the insertion action of differently sized components). This effectively limits the degree of its deformation under elevated temperature conditions. Furthermore, through the provision of additional mutually engaging structures between the grounding member 123 and the fixing member 121, such as the adaptation between the latching hook portion 1231 and the opening 1211 described above, effective constraint on the deformation tendency at the middle portion of the retaining member 122 in the transverse direction of the insulating housing 11 (respective to the extending direction of the retaining member 122) is achieved. This enhances structural strength and minimizes the deformation degree of the retaining member 122 itself, thereby improving the coplanarity of the solder feet 1232 extending from the grounding member 123 (to abut against respective ground terminals 1201).

As shown in FIGS. 3c-3d, the grounding member 123 comprises: a body 1230, plate-shaped and extending in the transverse direction; the latching hook portion 1231, protruding from the body 1230 in the vertical direction and configured as a cantilever arrangement deflected towards the fixing member 121, the latching hook portion 1231 being adapted for insertion-fit engagement with the through hole 1215; and a plurality of solder feet 1232, arranged on a side of the body 1230 opposite to the latching hook portion 1231, protruding from the body 1230 in the vertical direction and deflected away from the fixing member 121 in the longitudinal direction.

The latching hook portion 1231, as shown in FIGS. 3c-3f, is located at a middle portion of the body 1230 in the transverse direction and has a Z-shape deflected in the vertical direction. In an embodiment, as an example, for instance, the latching hook portion 1231 and the plurality of solder feet 1232 are formed from the body 1230 by a sheet metal forming process, for example, by stamping and bending from the body 1230; the latching hook portion 1231 and the solder feet 1232 are formed with the body 1230 in a piece of sheet metal.

In an exemplary embodiment of the present disclosure, the grounding member 123 can be made of various conductive materials and can be grounded in various ways. For example, the grounding member 123 can be electrically connected directly or indirectly to the ground terminals 1201, or to grounding components on electrical equipment or its circuit board. Thus, based on this specific arrangement of the grounding member 123, it is achieved that the latching hook portion 1231 of the grounding member 123 is adapted for insertion-fit engagement and effectively locks into the opening 1211 during operation, and can be unlocked by elastic pressing and can be manually removed from the opening 1211 when not in operation.

Moreover, considering that the side of the grounding member 123 opposite to the side where the solder feet 1232 are distributed forms a protruding Z-shaped feature, the latching hook portion 1231 on the grounding member 123 (e.g., the Z-shaped configuration as illustrated and described above) is inserted into and passes through the chute-like opening 1211 of the fixing member 121 made of plastic material. The Z-shaped latching hook portion 1231 abuts against the inner surface of the opening 1211 with one side surface, thereby achieving elastic locking between them. Consequently, during the soldering process of the ground terminals 1201 to the solder feet 1232 of the grounding member 123, on the side of the grounding member 123 facing the fixing member 121, the latching hook portion 1231 pulls against the inner sidewall of the opening 1211. Simultaneously, on the other side of the grounding member 123 facing the retaining member 122, the ground terminals 1201 and the solder feet 1232 of the grounding member 123 are soldered together to form a conductive connection. Thus, the deformations on both sides at least partially offset each other, preventing outward deformation of the retaining member 122, thereby enhancing structural strength to reinforce the retaining member 122 while improving the coplanarity of the solder feet 1232 of the grounding member 123.

Therefore, the deformation tendency introduced by the insertion-fit engagement between the latching hook portion 1231 and the opening 1211 essentially counteracts the deformation tendency on the other side of the grounding member 123 caused by temperature rise due to soldering. The two tendencies at least partially cancel each other out, thereby respectively suppressing the outward deformation of the retaining member 122. Thus, with a simple and easily processed structure of the grounding member 123, effective suppression of the deformation tendency of the retaining member 122 at its middle portion in its extending direction, as described above, is achieved. This effectively weakens or even cancels out the arching deformation of the retaining member 122 caused by, for example, soldering-induced temperature rise. Compared to the prior art, the grounding member 123 and fixing member 121 arranged in this way in the present disclosure essentially achieve at least partial cancellation of the temperature-induced deformation at the middle portion of the retaining member 122 located on the backside of the grounding member 123. This is superior to the retaining member 122 in current conventional electrical connectors lacking such engagement influence, as the latter cannot achieve this technical effect of resisting arching deformation at the middle portion of the retaining member 122 under soldering-induced temperature rise.

As shown in FIG. 2b, the conductive terminals 120 of each terminal assembly 12 include a plurality of pairs of signal terminals 1202 and a plurality of pairs of ground terminals 1201 arranged alternately in a one-to-one correspondence relationship. Each pair of signal terminals 1202 is arranged side by side in the transverse direction, and the two ground terminals 1201 of each pair of ground terminals 1201 are respectively located on opposite sides of the respective pair of signal terminals 1202 in the transverse direction.

As a typical exemplary embodiment, for example, as shown in FIG. 2b, the plurality of conductive terminals 120 of each terminal assembly 12 include at least one pair of differential signal terminals 1202 and the at least one pair of ground terminals 1201. Respective pair of differential signal terminals 1202 are arranged adjacent to each other, and ground terminals 1201 in each pair of ground terminals 1201 are positioned on opposite sides of the respective pair of differential signal terminals 1202 in the transverse direction perpendicular to the longitudinal direction. Thus, by positioning each pair of ground terminals 1201 on opposite sides of the respective pair of differential signal terminals 1202 in the transverse direction, signal shielding is provided between adjacent pairs of differential signal terminals 1202 in the same row.

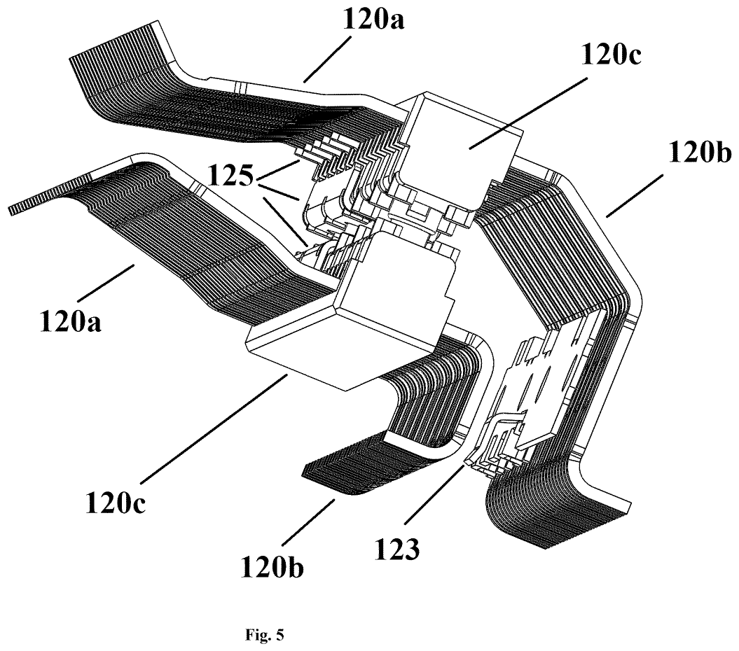

The respective installation segments 120b of the conductive terminals 120 of the two terminal assemblies 12 are spaced apart in the vertical direction, as shown in FIGS. 5-6, to define an insertion space 124, as shown in FIGS. 2f-3b, for receiving connection terminals of a mating connector. A respective free end of each conductive terminal 120 serves as a contact segment 120a configured to make conductive contact with a respective connection terminal of the mating connector.

In a further exemplary embodiment, as an example, the fixing member 121 is fixed to an inner wall of the insulating housing 11. As shown in FIG. 3d, the fixing member 121 has recesses 1213 on both sides in the longitudinal direction respectively for at least partially constraining the installation segments 120b of the respective ground terminals 1201 of the two terminal assemblies 12.

The installation segments 120b of the respective ground terminals 1201 of the one terminal assembly 12 of the two terminal assemblies 12 extend across the fixing member 121 in the longitudinal direction into respective recesses 1213 on the side of the fixing member 121 facing the grounding member 123. The contact segments 120a of the respective ground terminals 1201 of both terminal assemblies 12 are all located on another side of the fixing member 121 away from the grounding member 123. The installation segments 120b of the respective ground terminals 1201 of the other terminal assembly 12 of the two terminal assemblies 12 extend within respective recesses 1213 on the other side of the fixing member 121 away from the grounding member 123.

Based on the above arrangement of the fixing member 121, it facilitates the installation segments 120b of the respective conductive terminals 120 of the two terminal assemblies 12 being constrained within the respective recesses 1213 on both sides of the fixing member 121, thereby constraining the displacement of the conductive terminals 120 of each terminal assembly 12 in the transverse direction of the insulating housing 11. Furthermore, the respective installation segments 120b of the conductive terminals 120 of the two terminal assemblies 12 are located on both sides of the fixing member 121 itself, facilitating a symmetrical distribution of the installation segments 120b of the respective conductive terminals 120 of the two terminal assemblies 12 on both sides relative to the fixing member 121 and symmetrical connection to the circuit board, promoting reasonable wiring on the circuit board.

Moreover, further, for example respectively, the plurality of solder feet 1232 abut against the installation segments 120b of the respective ground terminals 1201 of the one terminal assembly 12 (e.g., the terminal assembly 12 whose conductive terminals 120 extend across the fixing member 121 as shown) to establish the conductive connection therebetween.

As shown in FIGS. 3c-3e, for example, each solder foot 1232 comprises: a base portion 1232a, extending from the body 1230 in the longitudinal direction; and a pair of wing portions 1232b, respectively extending from the base portion 1232a on opposite sides in the transverse direction.

And, further, for example, in response to insertion of the grounding member 123 towards the fixing member 121 in the vertical direction, the latching hook portion 1231 engages with the opening 1211 in an insertion-fit manner, and the pair of wing portions 1232b respectively abut against a respective pair of ground terminals 1201 to form a conductive connection, for example, through a soldering process.

Through this arrangement, simultaneously during the soldering process of the ground terminals 1201 to the solder feet 1232 of the grounding member 123, the latching hook portion 1231 on the grounding member 123 (e.g., the Z-shaped configuration as illustrated and described above) is inserted into and passes through the chute-like opening 1211 of the fixing member 121 made of plastic material. The Z-shaped latching hook portion 1231 abuts against the inner surface of the opening 1211 with one side surface, thereby achieving elastic locking between them. Consequently, on the side of the grounding member 123 facing the fixing member 121, the latching hook portion 1231 pulls against the inner sidewall of the opening 1211. Thus, the deformations on both sides of the grounding member 123 at least partially offset each other, preventing outward deformation of the retaining member 122, thereby enhancing structural strength to reinforce the retaining member 122 while improving the coplanarity of the solder feet 1232 of the grounding member 123.

Additionally, as shown in FIGS. 2a, 2d-3b, and 5-6, each terminal assembly 12 further comprises an installation base 120c. The plurality of conductive terminals 120 of each terminal assembly 12 extend side by side through the installation base 120c in the longitudinal direction. The contact segment 120a and the installation segment 120b of each conductive terminal 120 are connected within the installation base 120c.

In a further embodiment, as an example, the respective installation bases 120c of the two terminal assemblies 12 are provided on surfaces facing each other with at least one of protrusions and recesses adapted for mutual engagement. In a more specific exemplary embodiment, for example, the surface of the respective installation base 120c of the one terminal assembly 12 facing the other terminal assembly 12 is formed with a first engagement portion, and the surface of the respective installation base 120c of the other terminal assembly 12 facing the one terminal assembly 12 is formed with a second engagement portion adapted to engage with the first engagement portion. Each of the first and second engagement portions includes at least one of a plurality of protrusions and a plurality of recesses. Thus, by means of the mutual engagement of the respective installation bases 120c of the two terminal assemblies 12, the two terminal assemblies 12 are relatively fixed.

Moreover, as an example, the installation base 120c is, for example, disposed within the insulating housing 11 and fixed relative to the insulating housing 11. For instance, protrusions may be formed on two opposite outer side walls of the installation base 120c, while respective grooves or holes may be formed on the side walls of the insulating housing 11. The protrusions can snap into or engage with the grooves or holes to fix the installation base 120c to the insulating housing 11, thereby fixedly retaining the terminal assembly 12 within the insulating housing 11. It will be understood that this retaining method is merely exemplary, and the terminal assembly 12 may also be retained or installed within the insulating housing 11 in other suitable ways.

As shown in FIG. 4, the retaining member 122 has a row of through holes 1221 extending in the vertical direction. The installation segments 120b of the respective ground terminals 1201 of the one terminal assembly 12 extending across the fixing member 121 in the longitudinal direction extend through the row of through holes 1221 of the retaining member 122 within respective recesses on the side of the fixing member 121 facing the grounding member 123. And, as an example, the end portions of the installation segments 120b of the respective ground terminals 1201 of the two terminal assemblies 12 are bent oppositely in the longitudinal direction for grounding respectively, thereby facilitating a compact arrangement of the ground terminals 1201 relative to the circuit board within limited space.

Also, as an example, as shown in the figures, a side of at least one installation base 120c facing the fixing member 121 is provided with a row of protrusions spaced apart in the transverse direction. The side of the fixing member 121 facing the installation base 120c is respectively provided with at least one row of recesses 1216 arranged in the transverse direction and adapted to engage with the row of protrusions of the installation base 120c, for mutual engagement and detachable locking between the at least one installation base 120c and the fixing member 121.

As shown in FIGS. 2f-3b, the internal components 20 in the electrical connector 1 may further include an additional grounding member 125, comprising two additional grounding halves 1250. The two additional grounding halves 1250 are, for example, respectively conductively connected to a portion of the respective ground terminals 1201 of the two terminal assemblies 12 and have elastic conductive sheets abutting against each other to facilitate achieving a common potential. Through this arrangement, the ground terminals 1201 of the respective terminal assemblies 12 are commonly grounded together, and then conductively connected to the grounding member 123 via the installation segments 120b of the respective ground terminals 1201 of the terminal assembly 12 extending across the fixing member 121 to achieve final grounding.

Based on the electrical connector 1 arranged as described above, the following superior technical effects compared to existing solutions in the art can be achieved:

By additionally providing mutually engaging structures on the grounding member 123 and the fixing member 121, such as the latching hook portion 1231 on the grounding member 123 (e.g., in a Z-shaped configuration) and the opening 1211 on the fixing member 121, the latching hook portion 1231 is inserted into and passes through the chute-like opening 1211 of the fixing member 121 made of plastic material. Thus, the latching hook portion 1231 abuts against the inner surface of the opening 1211 with one side surface, achieving elastic locking between them. Moreover, by providing a plurality of holes 1233 on the grounding member 123 adapted for passage of the plurality of protrusions 1220 on the retaining member 122 located on the backside of the grounding member 123, and providing slots 1212 on the fixing member 121 adapted to receive the plurality of protrusions 1220, the retaining member 122 follows the relative movement between the fixing member 121 and the grounding member 123, shifting or tending to shift accordingly.

Therefore, during the soldering process of the ground terminals 1201 to the solder feet 1232 of the grounding member 123, on the side of the grounding member 123 facing the fixing member 121, the latching hook portion 1231 pulls against the inner sidewall of the opening 1211. Simultaneously, on the other side of the grounding member 123 facing the retaining member 122, the ground terminals 1201 and the solder feet 1232 of the grounding member 123 are soldered together to form a conductive connection. This causes the deformations on both sides of the grounding member 123 to at least partially offset each other, preventing outward deformation of the retaining member 122, thereby enhancing structural strength to reinforce the retaining member 122 while improving the coplanarity of the solder feet 1232 of the grounding member 123.

Thus, the electrical connector 1, as described above, has a simple structure that can achieve effective constraint on the middle portion of the retaining member 122 to suppress deformation, enhance structural strength, and improve solder foot 1232 coplanarity by additionally providing mutually engaging structures on the grounding member 123 and other fixed structures.

The foregoing description of the electrical connector 1 in the preceding embodiments of the present disclosure is intended to be illustrative, not restrictive. Although the present disclosure has been described with reference to the accompanying drawings, the embodiments disclosed in the drawings are intended to exemplify the preferred embodiments of the present disclosure and should not be construed as a limitation on the present disclosure.

Therefore, those skilled in the art will understand that the embodiments described above are exemplary, and those skilled in the art can make improvements. Structures described in various embodiments can be modified and freely combined without conflict in structure or principle. Such changes should fall within the protection scope of the present disclosure.

The breadth and scope of the present disclosure should not be limited by any of the above-described exemplary embodiments but should be defined only in accordance with the following claims and their equivalents.

It should be noticed that the wording “comprising” does not exclude other components or steps, and the wording “a/an” or “one” does not exclude multiple or a plurality of. Furthermore, any reference numeral(s) in the claims should not be construed to be limitation of the scope of the present disclosure.

1. An electrical connector, comprising:
a shell;
an insulating housing open at both ends along a longitudinal direction and installed within the shell;
a pair of terminal assemblies, each terminal assembly is disposed within the insulating housing and has a plurality of conductive terminals extending parallel to the longitudinal direction and arranged side by side in a transverse direction perpendicular to the longitudinal direction, the plurality of conductive terminals include at least one pair of signal terminals and at least one pair of ground terminals, each conductive terminal has a free end and an installation segment at an end opposite the free end;
a fixing member installed within the insulating housing and having an opening on a side;
a retaining member at least partially retained by the fixing member; and
a grounding member between the fixing member and the retaining member in the longitudinal direction, the grounding member is in conductive connection with the installation segments of the ground terminals of one terminal assembly and has a latching hook portion insertion fit with the opening.

2. The electrical connector of claim 1, wherein, on a side of the fixing member facing the grounding member, the opening and a plurality of slots extend through the fixing member in a vertical direction perpendicular to both the longitudinal direction and the transverse direction.

3. The electrical connector of claim 2, wherein, on a side of the retaining member facing the grounding member, the retaining member has a plurality of protrusions insertably retained in the plurality of slots, the retaining member is fixed at both ends thereof to the insulating housing, the grounding member has a plurality of holes through which the plurality of protrusions pass.

4. The electrical connector of claim 3, wherein the plurality of slots are recessed from a surface of the side of the fixing member facing the grounding member, and the plurality of slots linearly extend in the vertical direction through the fixing member, the opening of the fixing member is recessed from the surface of the side of the fixing member facing the grounding member and extends unidirectionally in the vertical direction through the fixing member to an edge of the fixing member.

5. The electrical connector of claim 3, wherein the fixing member has a stopper at the edge of the opening, the stopper continuously extends across the opening in the transverse direction and arches towards the grounding member, the stopper and an inner wall of the opening together define a through hole extending in the vertical direction.

6. The electrical connector of claim 5, wherein the grounding member has a body and a plurality of solder feet, the body is plate-shaped and extends in the transverse direction, the latching hook portion protrudes from the body in the vertical direction and is in a cantilever arrangement deflected towards the fixing member, the latching hook portion is insertion fit into the through hole of the fixing member, the plurality of solder feet are arranged on a side of the body opposite the latching hook portion, protrude from the body in the vertical direction, and are deflectable away from the fixing member in the longitudinal direction.

7. The electrical connector of claim 6, wherein the latching hook portion is at a middle portion of the body in the transverse direction, the latching hook portion has a Z-shape when deflected in the vertical direction.

8. The electrical connector of claim 7, wherein the latching hook portion and the plurality of solder feet are formed with the body in a piece of sheet metal.

9. The electrical connector of claim 6, wherein the conductive terminals of each terminal assembly include a plurality of pairs of signal terminals and a plurality of pairs of ground terminals arranged alternately in a one-to-one correspondence relationship, each pair of signal terminals is arranged side by side in the transverse direction, and the ground terminals of each pair of ground terminals are respectively located on opposite sides of one of the pairs of signal terminals in the transverse direction.

10. The electrical connector of claim 9, wherein the plurality of conductive terminals of each terminal assembly include at least one pair of differential signal terminals and the at least one pair of ground terminals, respective pairs of differential signal terminals are arranged adjacent to each other, and ground terminals in each pair of ground terminals are positioned on opposite sides of the respective pair of differential signal terminals in the transverse direction perpendicular to the longitudinal direction.

11. The electrical connector of claim 10, wherein the installation segments of the conductive terminals of the terminal assemblies are spaced apart in the vertical direction to define an insertion space for receiving connection terminals of a mating connector, the free end of each conductive terminal is a contact segment conductively contacting a connection terminal of the mating connector.

12. The electrical connector of claim 11, wherein the fixing member is fixed to an inner wall of the insulating housing, the fixing member has recesses on a pair of sides of the fixing member in the longitudinal direction, the recesses at least partially constrain the installation segments of the ground terminals.

13. The electrical connector of claim 12, wherein the installation segments of the ground terminals of one terminal assembly extend across the fixing member in the longitudinal direction into recesses on the side of the fixing member facing the grounding member, the installation segments of the ground terminals of the other terminal assembly extend within recesses on an other side of the fixing member away from the grounding member, and the contact segments of the ground terminals of both terminal assemblies are all located on the other side of the fixing member away from the grounding member.

14. The electrical connector of claim 13, wherein the plurality of solder feet abut against the installation segments of the ground terminals of one terminal assembly to establish the conductive connection therebetween.

15. The electrical connector of claim 10, wherein each solder foot has a base portion and a pair of wing portions, the base portion extends from the body in the longitudinal direction, the pair of wing portions each extend from one opposite side of the base portion in the transverse direction.

16. The electrical connector of claim 15, wherein, in response to insertion of the grounding member towards the fixing member in the vertical direction, the latching hook portion engages with the opening in an insertion fit, and the pair of wing portions abut against a respective pair of ground terminals to form a conductive connection.

17. The electrical connector of claim 13, wherein each terminal assembly includes an installation base, the plurality of conductive terminals of each terminal assembly extend side by side through the installation base in the longitudinal direction, the contact segment and the installation segment of each conductive terminal are connected within the installation base.

18. The electrical connector of claim 17, wherein respective installation bases of the two terminal assemblies have, on surfaces thereof facing each other, at least one of protrusions and recesses adapted for mutual engagement.

19. The electrical connector of claim 17, wherein the retaining member has a row of through holes extending in the vertical direction, the installation segments of the respective ground terminals of the one terminal assembly extending across the fixing member in the longitudinal direction extend through the row of through holes of the retaining member within respective recesses on the side of the fixing member facing the grounding member.

20. The electrical connector of claim 19, wherein end portions of the installation segments of the respective ground terminals of the two terminal assemblies are bent oppositely in the longitudinal direction.
